(19) United States
(12) Patent Application Publication
(10) Pub. No.: US 2026/0311344 A1
(43) Pub. Date: Oct. 8, 2026

(54) VIDEO PROCESSING METHOD AND APPARATUS, DEVICE, STORAGE MEDIUM, AND COMPUTER PROGRAM PRODUCT

(71) Applicant: The Hong Kong University of Science and Technology (Guangzhou), Guangzhou (CN)

(72) Inventors: Hui Xiong, Guangzhou (CN); Yunfan Lu, Guangzhou (CN); Zipeng Wang, Guangzhou (CN)

(21) Appl. No.: 19/466,494

(22) Filed: Feb. 1, 2026

Related U.S. Application Data
(63) Continuation-in-part of application No. PCT/CN2025/098652, filed on May 30, 2025.

(30) Foreign Application Priority Data
May 30, 2024 (CN) 202410692343.2

(51) Int. Cl. G06T 7/246; H04N 7/01

(52) U.S. Cl. CPC G06T 7/246; H04N 7/0117; H04N 7/0127; G06T 2207/10016; G06T 2207/20016; G06T 2207/20084; G06T 2207/30232; G06T 2207/30236

(57) ABSTRACT

Provided are a video processing method and apparatus, a device, a storage medium, and a computer program product. The method includes: obtaining a to-be-processed video acquired by an event camera and event data corresponding to the to-be-processed video; performing event feature extraction on the event data to obtain a motion region feature corresponding to the to-be-processed video; performing frame feature extraction on the to-be-processed video and the event data to obtain a holistic motion feature corresponding to the to-be-processed video, where the holistic motion feature is used to represent a dependency with respect to time and space of the to-be-processed video; fusing the motion region feature and the holistic motion feature to obtain a fused feature; and performing video reconstruction based on the fused feature to obtain a target video. The method provided in this application can improve a resolution and frame rate of a restored video.

### CROSS REFERENCE TO RELATED APPLICATION

This application is a continuation-in-part of International Patent Application No. PCT/CN2025/098652, filed on May 30, 2025. This application claims priority to Chinese Patent Application No. 202410692343.2, filed with the China National Intellectual Property Administration (CNIPA) on May 30, 2024 and entitled “VIDEO PROCESSING METHOD AND APPARATUS, DEVICE, STORAGE MEDIUM, AND COMPUTER PROGRAM PRODUCT”, all of which are incorporated herein by reference in their entireties.

### TECHNICAL FIELD

This application belongs to the field of computer vision, and in particular, relates to a video processing method and apparatus, a device, a storage medium, and a computer program product.

### BACKGROUND

Implicit neural representation (INR) is a method for representing input information such as an image, audio, and a point cloud as a function through a neural network. It may be used in scenarios such as video restoration. Specifically, an image or a video is represented as an implicit field for decoding at an arbitrary resolution.

However, in the related art, an INR-based continuous space-time video super-resolution (C-STVSR) method usually assumes that linear motion exists between frames and generates a feature at an arbitrary spatiotemporal position between two frames through interpolation or feature warping. This method limits C-STVSR's ability to capture fast and nonlinear motion and long-term dependence in a complex dynamic scene, thereby reducing a resolution and frame rate of a video.

### SUMMARY

The embodiments of this application provide a video processing method and apparatus, a device, a storage medium, and a computer program product, which can improve a resolution and frame rate of a processed video, to improve video quality.

According to a first aspect, an embodiment of this application provides a video processing method. The method includes: obtaining a to-be-processed video acquired by an event camera and event data corresponding to the to-be-processed video; performing event feature extraction on the event data to obtain a motion region feature corresponding to the to-be-processed video; performing frame feature extraction on the to-be-processed video and the event data to obtain a holistic motion feature corresponding to the to-be-processed video, where the holistic motion feature is used to represent a dependency with respect to time and space of the to-be-processed video; fusing the motion region feature and the holistic motion feature to obtain a fused feature; and performing video reconstruction based on the fused feature to obtain a target video.

According to a second aspect, an embodiment of this application provides a video processing apparatus. The apparatus includes: a data obtaining module configured to obtain a to-be-processed video acquired by an event camera and event data corresponding to the to-be-processed video; a first feature extraction module configured to perform event feature extraction on the event data to obtain a motion region feature corresponding to the to-be-processed video; a second feature extraction module configured to perform frame feature extraction on the to-be-processed video and the event data to obtain a holistic motion feature corresponding to the to-be-processed video, where the holistic motion feature is used to represent a dependency with respect to time and space of the to-be-processed video; a feature fusion module configured to fuse the motion region feature and the holistic motion feature to obtain a fused feature; and a video reconstruction module configured to perform video reconstruction based on the fused feature to obtain a target video.

According to a third aspect, an embodiment of this application provides an electronic device, including a processor and a memory that stores a computer program instruction. The processor, when executing the computer program instruction, implements the video processing method according to the first aspect.

According to a fourth aspect, an embodiment of this application provides a non-transitory computer-readable storage medium. The non-transitory computer-readable storage medium stores a computer program instruction. The computer program instruction, when executed by a processor, implements the video processing method according to the first aspect.

According to a fifth aspect, an embodiment of this application provides a computer program product, including a non-transitory computer-readable storage medium that contains computer-readable program code. The computer-readable program code in the computer program product, when executed by a processor of an electronic device, causes the electronic device to perform the video processing method according to the first aspect.

It can be learned from the foregoing content that in the embodiments of this application, the event data corresponding to the to-be-processed video contains rich event information, and nonlinear motion and long-term dependence of a moving object in the to-be-processed video can be captured by performing event feature extraction on the event data in the to-be-processed video, to provide a basis for improving the to-be-processed video's resolution and frame rate. In addition, in the embodiments of this application, dynamic motion and edge details in the to-be-processed video can be captured by performing feature extraction on the event data, and long-term motion dependencies can be modeled by extracting the holistic motion feature from the to-be-processed video and the event data. Dynamic changes in video content can be comprehensively understood by combining the features extracted through the foregoing two feature extraction methods, to improve the reconstructed target video's resolution and frame rate.

It can be learned that in the method provided in the embodiments of this application, the target video with a high resolution and frame rate can be obtained by processing the to-be-processed video.

### BRIEF DESCRIPTION OF THE DRAWINGS

To describe the technical solutions in the embodiments of this application more clearly, the following briefly describes the accompanying drawings required for the embodiments of this application. A person of ordinary skill in the art may still derive other drawings from these accompanying drawings without creative efforts.

FIG. 1 is a schematic flowchart of a video processing method according to an embodiment of this application;

FIG. 2 is a schematic architectural diagram of a video processing model according to an embodiment of this application;

FIG. 3 is a schematic structural diagram of a temporal pyramid model according to an embodiment of this application;

FIG. 4 is a schematic diagram of experimental visualization results on an Adobe dataset according to an embodiment of this application;

FIG. 5 is a schematic diagram of experimental visualization results on a TimeLens++ dataset according to an embodiment of this application;

FIG. 6 is a schematic diagram of experimental visualization results on a color event camera (CED) dataset according to an embodiment of this application;

FIG. 7 is a schematic diagram of experimental visualization results on a TimeLens++ dataset according to an embodiment of this application;

FIG. 8 is a schematic structural diagram of a video processing apparatus according to another embodiment of this application;

FIG. 9 is a schematic structural diagram of a first feature extraction module according to another embodiment of this application;

FIG. 10 is a schematic structural diagram of a video processing apparatus according to another embodiment of this application;

FIG. 11 is a schematic structural diagram of a video reconstruction module according to another embodiment of this application; and

FIG. 12 is a schematic structural diagram of an electronic device according to still another embodiment of this application.

### DETAILED DESCRIPTION

Features of various aspects and exemplary embodiments of this application are described below in detail. To make the objectives, technical solutions, and advantages of this application clearer, this application is further described in detail below with reference to the accompanying drawings and embodiments. It should be understood that the embodiments described herein are merely used to explain this application, rather than to limit this application. A person skilled in the art can implement this application without some of these specific details. The following description of the embodiments is intended only to provide a better understanding of this application by illustrating examples of this application.

It should be noted that relational terms herein such as first and second are merely used to distinguish one entity or operation from another entity or operation without necessarily requiring or implying any actual such relationship or order between such entities or operations. In addition, terms “include”, “comprise”, or their any other variations are intended to cover a non-exclusive inclusion, such that a process, a method, an article, or a device that includes a series of elements not only includes those elements, but also includes other elements that are not explicitly listed, or also includes inherent elements of the process, the method, the article, or the device. Without more restrictions, the elements defined by the sentence “including . . . ” do not exclude the existence of other identical elements in a process, method, article, or device including the elements.

For ease of understanding, before the solution provided in this application is described, the background of the solution provided in this application is described first.

In the related art, due to a limited input/output (I/O) bandwidth and sensor size, a camera system can only record a video at a fixed resolution and frame rate. This affects application to computer vision, such as immersive experience in virtual reality (VR) and traffic analysis in autonomous driving. To overcome this limitation, in the related art, C-STVSR may be used to improve both a resolution and a frame rate of the video.

In recent years, INR has been applied to video restoration. Specifically, an image or a video is represented as an implicit field to enable decoding at an arbitrary resolution. However, an existing INR-based C-STVSR method has limitations in that it usually assumes that linear motion exists between frames and generates a feature at an arbitrary spatiotemporal position between two frames through interpolation or feature warping. This method limits C-STVSR's ability to capture fast and nonlinear motion and long-term dependence (involving more than two frames) in a complex dynamic scene.

To resolve the problems in the prior art, the embodiments of this application provide a video processing method and apparatus, a device, a storage medium, and a computer program product. The following first describes the video processing method provided in the embodiments of this application.

The method provided in the embodiments of this application aims to capture holistic dependence and regional motion based on INR with assistance by an event camera. The event camera has a high temporal resolution and low latency. A feature extraction framework is designed to fully utilize rich temporal information provided by event data and capture regional nonlinear motion and long-term dependence. The long-term dependence is captured through spatial and temporal embedding.

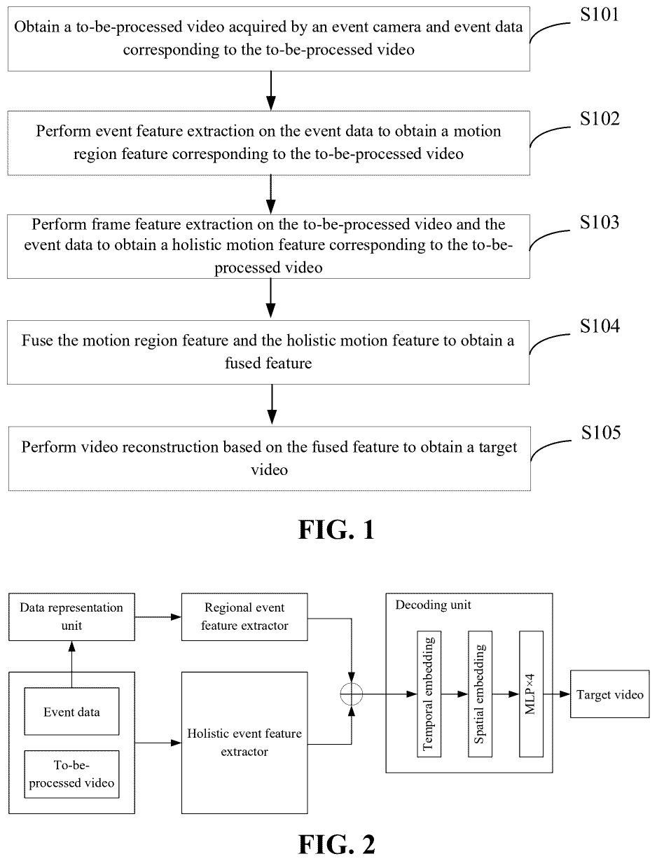

FIG. 1 is a schematic flowchart of a video processing method according to an embodiment of this application. As shown in FIG. 1, the method includes the following steps.

S101: Obtain a to-be-processed video acquired by an event camera and event data corresponding to the to-be-processed video.

In step S101, the event camera is a camera that acquires an image through a dynamic vision sensor. The event camera may acquire an “event” (namely, the event data) in an image generation process, for example, a change in pixel brightness. In the embodiments of this application, each piece of event data is used to represent pixel intensity change information at a specific time and position in the video.

In step S101, the to-be-processed video may be a to-be-restored video, for example, a blurred video acquired by the event camera. In the embodiments of this application, the to-be-processed video includes a plurality of RGB frames.

It should be noted that in the embodiments of this application, the event camera has a high temporal resolution and low latency. Based on this, subtle motion changes in the to-be-processed video can be obtained by acquiring the to-be-processed video and the event data of the to-be-processed video through the event camera, to provide a basis for restoring the to-be-processed video.

S102: Perform event feature extraction on the event data to obtain a motion region feature corresponding to the to-be-processed video.

In step S102, feature extraction may be performed on the event data through a regional event feature extractor, and a motion region feature that contains dynamic motion and edge details may be obtained. Detailed motion information in the to-be-processed video can be obtained by performing feature extraction on the event data in step S102. The detailed information can improve video restoration accuracy and precision, to ensure the video's resolution and frame rate.

S103: Perform frame feature extraction on the to-be-processed video and the event data to obtain a holistic motion feature corresponding to the to-be-processed video.

In step S103, the holistic motion feature is used to represent a dependency with respect to time and space of the to-be-processed video.

In an example, the holistic motion feature corresponding to the to-be-processed video may be extracted through a holistic event feature extractor. The holistic event feature extractor may be a Swin Transformer-based feature extractor, which can model long-term dependence between time and space in a large range.

S104: Fuse the motion region feature and the holistic motion feature to obtain a fused feature.

It should be noted that the motion region feature and the holistic motion feature can reflect information about dynamic changes in content of the to-be-processed video. Therefore, after the motion region feature and the holistic motion feature are extracted, the two features are fused, and video reconstruction is performed based on the fused feature such that a reconstructed video can clearly show motion details in the video, to improve the video's resolution and frame rate.

S105: Perform video reconstruction based on the fused feature to obtain a target video.

In step S105, video reconstruction may be implemented by performing spatial-temporal decoding on the fused feature through an INR technology. In a video reconstruction process, learnable temporal embedding as an attention vector, and spatial embedding and decoding technologies are introduced to effectively reconstruct video frames without optical flow estimation, thereby improving video reconstruction efficiency and precision, and the reconstructed video's resolution and frame rate.

Based on the solution defined by steps S101 to S105, it can be learned that in the embodiments of this application, the event data corresponding to the to-be-processed video contains rich event information, and nonlinear motion and long-term dependence of a moving object in the to-be-processed video can be captured by performing event feature extraction on the event data in the to-be-processed video, to provide a basis for improving the to-be-processed video's resolution and frame rate. In addition, in the embodiments of this application, dynamic motion and edge details in the to-be-processed video can be captured by performing feature extraction on the event data, and long-term motion dependencies can be modeled by extracting the holistic motion feature from the to-be-processed video and the event data. Dynamic changes in video content can be comprehensively understood by combining the features extracted through the foregoing two feature extraction methods, to improve the reconstructed target video's resolution and frame rate.

It can be learned that in the method provided in the embodiments of this application, the target video with a high resolution and frame rate can be obtained by processing the to-be-processed video.

In an embodiment, FIG. 2 is an architectural diagram of a video processing model for implementing the method provided in the embodiments of this application. It can be learned from FIG. 2 that the video processing model mainly includes a data representation unit, a regional event feature extractor, a holistic event feature extractor, and a decoding unit. The data representation unit is configured to perform data representation on event data to more accurately capture motion changes in a video. The regional event feature extractor is configured to extract local dynamic change information and edge information in the event data. The holistic event feature extractor is configured to model long-term dependence between time and space. The decoding unit is configured to decode data to implement video reconstruction.

The following describes the steps for implementing the method provided in the embodiments of this application with reference to FIG. 2.

First, after the to-be-processed video acquired by the event camera and the event data are obtained, event feature extraction may be performed on the event data to obtain motion feature information corresponding to the to-be-processed video. Then, regional event feature extraction may be performed on the motion feature information to obtain the motion region feature corresponding to the to-be-processed video.

In an embodiment, event feature extraction may be performed on the event data through the data representation unit to obtain the motion feature information corresponding to the to-be-processed video. Specifically, the data representation unit performs multi-level temporal pyramid representation on the event data by using a time granularity corresponding to each pyramid level in a temporal pyramid model to obtain the motion feature information corresponding to the to-be-processed video.

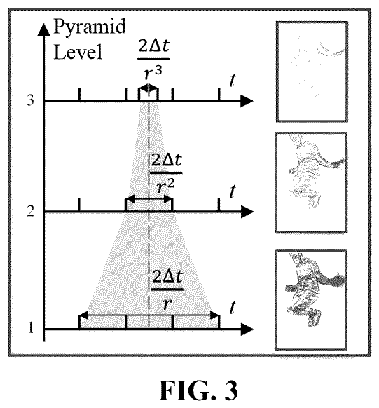

For example, in FIG. 2, after the to-be-processed video and the event data are acquired, the data representation unit performs temporal pyramid representation on the event data. The temporal pyramid model includes a plurality of pyramid levels. Duration of each pyramid level is a fraction of duration of a previous pyramid level. For example, in a structural diagram of a temporal pyramid model shown in FIG. 3, duration of a first pyramid level is

$$\frac{2 Δ t}{r} ;$$

duration of a second pyramid level is

$$\frac{2 Δ t}{{r}^{2}} ,$$

which is 1/r of the duration of the first pyramid level; and duration of a third pyramid level is

$$\frac{2 Δ t}{{r}^{3}} ,$$

which is 1/r of the duration of the second pyramid level. Δt represents time. r represents a division scale. r is a positive integer.

In the embodiments of this application, the temporal pyramid model may have a structure of 7 pyramid levels. In this scenario, the temporal pyramid model can most effectively capture fast and slight dynamic changes. Each pyramid level represents a different time granularity, to ensure that the motion information in the video can be comprehensively understood.

In addition, a dynamically adjusted resolution (obtained by scaling down an original video resolution by a factor such as ½, ¼, or ⅛) may further be used for each pyramid level to reduce a computational burden while retaining sufficient motion details.

It should be noted that in the embodiments of this application, performing temporal pyramid representation on the event data through the temporal pyramid model can achieve a finer time granularity, to effectively reduce computational complexity while retaining important motion information.

To further improve accuracy of performing temporal pyramid representation on the event data through the temporal pyramid model, in practical application, the temporal pyramid model may further be dynamically adjusted based on the content of the to-be-processed video.

In an embodiment, dynamic characteristic data in the to-be-processed video is obtained, and then a level parameter corresponding to each pyramid level in the temporal pyramid model is adjusted based on the dynamic characteristic data.

In the foregoing embodiment, the dynamic characteristic data is used to represent motion data of a moving object in the to-be-processed video, for example, motion duration, a motion region, and a motion speed. The level parameter of the pyramid level includes at least one of a time span or a time granularity.

In an example, the time span and/or the time granularity of each pyramid level may be adaptively adjusted based on the dynamic characteristic data in the to-be-processed video to more accurately capture motion changes in the video.

In another embodiment, alternatively, event feature extraction may be performed on the event data by using a multi-scale time window to obtain the motion feature information corresponding to the to-be-processed video.

Specifically, dynamic characteristic data of at least one moving object in the to-be-processed video is obtained. Next, a time window corresponding to the dynamic characteristic data of the at least one moving object is determined based on a relationship between the dynamic characteristic data and the time window. Then, the event data is encoded by using the time window corresponding to the dynamic characteristic data of the at least one moving object to obtain the motion feature information corresponding to the to-be-processed video.

In the foregoing embodiment, the dynamic characteristic data is used to represent motion data of the at least one moving object in the to-be-processed video. In this embodiment, the event data may be encoded by using time windows with different sizes to capture various motion speeds from fast to slow, thereby enhancing the video processing model's adaptability to different motion patterns. Further, in practical application, after the event data is obtained, the video processing model may obtain a target time window matching the event data from a plurality of time windows, and then encode the event data by using the target time window, to obtain the motion feature information corresponding to the to-be-processed video.

Further, as shown in FIG. 2, after the motion feature information corresponding to the to-be-processed video is obtained, regional event feature extraction is performed on the motion feature information through the regional event feature extractor. Specifically, the regional event feature extractor extracts local dynamic change information and edge information in the motion feature information through a convolutional layer of a neural network and a multi-head self-attention mechanism to obtain the motion region feature corresponding to the to-be-processed video.

It should be noted that using the convolutional layer and the multi-head self-attention mechanism enables the regional event feature extractor to capture the local dynamic change information and edge information, to provide a basis for improving a resolution and frame rate of a restored video.

It should also be noted that in practical application, the regional event feature extractor may alternatively be a hybrid feature extraction network or a modular feature extractor. The hybrid feature extraction network combines different types of network structures such as a convolutional neural network and a graph neural network to make full use of their advantages in processing spatial information and modeling long-term dependence. Through modular design, the modular feature extractor allows different feature extraction modules to be dynamically combined and selected based on a characteristic of input data to adapt to diverse video content and scenarios.

In an embodiment, as shown in FIG. 2, the holistic event feature extractor extracts long-term dependence between time and space in the to-be-processed video from the to-be-processed video and the event data to determine a holistic motion trend (namely, the holistic motion feature) of the moving object in the to-be-processed video. After the motion region feature and the holistic motion feature are obtained, they are fused to obtain the fused feature. The fused feature is input to the decoding unit to implement video reconstruction.

Specifically, the decoding unit obtains an input target frame rate and target resolution corresponding to the target video, and determines a display time corresponding to each frame of image in the target video based on the target frame rate; next, performs temporal embedding on the fused feature to obtain a first fused feature corresponding to the display time; then, performs spatial embedding on the first fused feature to obtain a second fused feature corresponding to the target resolution; and finally, decodes the second fused feature to obtain the target video with the target frame rate and the target resolution.

In the foregoing embodiment, the target frame rate and the target resolution may be input by a user based on an actual requirement. The target frame rate and the target resolution are a frame rate and a resolution of the target video obtained after performing video reconstruction on the to-be-processed video.

For example, in FIG. 2, after the fused feature Rₜ is obtained, temporal embedding is performed on the fused feature, that is, a timestamp corresponding to the target frame rate is embedded into the fused feature to capture a feature at a time point with the timestamp (namely, a first fused feature Rₜₛ). Next, spatial embedding is implemented by embedding the target resolution into the first fused feature Rₜₛ, to obtain the second fused feature. Then, the target video can be obtained by decoding the second fused feature through a multilayer perceptron (MLP) (for example, a four-layer perceptron is used in FIG. 2).

It should be noted that in practical application, iterative refinement may be employed for decoding. Specifically, an iterative refinement mechanism is introduced based on initial spatial-temporal decoding, that is, a decoding process is repeated for a plurality of times in the foregoing manner, to gradually improve quality and precision of reconstructed video frames through a plurality of rounds of refinement.

In another embodiment, an image segmentation-based decoding strategy may alternatively be used to decode the second fused feature. Specifically, first, the to-be-processed video is segmented to obtain a plurality of regional videos. Next, the second fused feature corresponding to each of the regional videos is determined based on an association relationship between the regional videos and the second fused feature. Then, the second fused feature corresponding to each of the regional videos is decoded through a corresponding decoding strategy based on an association relationship between the decoding strategy and the second fused feature to obtain a target regional video corresponding to each of the regional videos. Finally, the target regional videos corresponding to the plurality of regional videos are combined to obtain the target video.

It should be noted that for the image segmentation-based decoding strategy, video frames are segmented first, and different decoding strategies are used for different regions, especially different processing for a dynamic background and a static background, to reconstruct a higher-quality video.

The method provided in the embodiments of this application may be applied to, but is not limited to, an urban traffic monitoring video enhancement scenario, a sports event live video processing scenario, and a VR content generation scenario. The following describes the method provided in the embodiments of this application by using the three scenarios as examples.

In the urban traffic monitoring video enhancement scenario, an urban traffic monitoring video with a low resolution and low frame rate and related event data captured through an event camera are obtained. The event data is processed through temporal pyramid representation. Feature extraction is performed on the urban traffic monitoring video and the event data through a hybrid feature extraction network. Finally, video output with a high resolution and high frame rate is generated through an iterative refinement decoding strategy, to obtain a traffic monitoring video with significantly improved clarity. A license plate and a pedestrian's facial feature can be clearly identified, to help improve traffic accident analysis accuracy and efficiency.

In the sports event live video processing scenario, a live video of a sports event and its event stream captured through a high-speed event camera are obtained. The input event stream and video (namely, the live video of the sports event) are processed through a temporal pyramid model and a modular feature extractor. A player and a background are separately processed through the image segmentation-based decoding strategy. A high-quality video is output through an INR-based spatial-temporal decoding technology. The foregoing manner improves quality of the live video of the sports event in real time while maintaining real-time performance of the live video of the sports event, delivering smoother motion (including resolution enhancement and motion smoothing), a clearer image, and greatly enhanced watching experience for audience.

In the VR content generation scenario, video data captured through an event camera is obtained. 3D-rendered content is processed through temporal pyramid representation and a hybrid feature extraction network. A resolution and smoothness are enhanced through an INR-based spatial-temporal decoding technology. Generated VR content delivers high definition and smooth motion, to significantly improve user immersion and experience.

In the embodiments of this application, performance of the method provided in the embodiments of this application is further verified through verification experiments.

In the verification experiments, a diverse dataset is used as a training dataset for the video processing model. The diverse dataset, such as Adobe240 fps or GoPro, encompasses rich dynamic scenes and different lighting conditions to enhance a generalization capability and adaptability of the video processing model. In addition, in the verification experiments, data augmentation technologies such as random cropping, rotation, and flipping may further be used to enhance diversity of training data, thereby improving the model's ability to handle a complex scene.

In a process of training the video processing model, a phased training method may be used. Specifically, pre-training is first performed at a low resolution, and then the resolution is gradually increased for fine-tuning. The phased training method can effectively accelerate the training process and improve precision of the model. For a loss function, a Charbonnier loss and a perceptual loss may be combined to consider pixel-level reconstruction precision and pay attention to perceptual quality of an image for a better visual effect.

For hardware and software environments, high-performance computing resources are selected, and a computing platform with a high-speed memory and a multi-core processor is used, such as a workstation equipped with NVIDIA RTX 3090 or a higher-performance GPU, to ensure training and inference efficiency. For a software environment, development may be conducted within a deep learning framework, such as PyTorch or TensorFlow, which provides rich APIs and optimization tools to facilitate model design and experimental verification.

In the verification experiments, experiments are separately conducted on an Adobe dataset, a GoPro dataset, a TimeLens++ dataset, and a CED dataset.

Results of super-resolution and frame interpolation experiments on the Adobe dataset and the GoPro dataset are shown in Table 1.

TABLE 1

| | | | GoPro- | GoPro- | Adobe- | Adobe- |
|---|---|---|---|---|---|---|
| VFI | VSR | M | Center | Average | Center | Average |
| Super | Bicubic | 19.8 | 27.04/0.7937 | 26.06/0.7720 | 26.09/0.7435 | 25.29/0.7279 |
| SloMo | EDVR | 19.8 + 20.7 | 28.24/0.8322 | 26.30/0.7960 | 27.25/0.7972 | 25.95/0.7682 |
| | BasicVSR | 19.8 + 6.3 | 28.23/0.8308 | 26.36/0.7977 | 27.28/0.7961 | 25.94/0.7679 |
| QVI | Bicubic | 29.2 | 26.50/0.7791 | 25.41/0.7554 | 25.57/0.7324 | 24.72/0.7114 |
| | EDVR | 29.2 + 20.7 | 27.43/0.8081 | 25.55/0.7739 | 26.40/0.7692 | 25.09/0.7406 |
| | BasicVSR | 29.2 + 6.3 | 27.44/0.8070 | 26.27/0.7955 | 26.43/0.7682 | 25.20/0.7421 |
| DAIN | Bicubic | 24.0 | 26.92/0.7911 | 26.11/0.7740 | 26.01/0.7461 | 25.40/0.7321 |
| | EDVR | 24.0 + 20.7 | 28.01/0.8239 | 26.37/0.7964 | 27.06/0.7895 | 26.01/0.7703 |
| | BasicVSR | 24.0 + 6.3 | 28.00/0.8227 | 26.46/0.7966 | 27.07/0.7890 | 26.23/0.7725 |

| | | | | | |
|---|---|---|---|---|---|
| Zooming Slow Mo | 11.10 | 30.69/0.8847 | —/— | 30.26/0.8821 | —/— |
| TMNet | 12.26 | 30.14/0.8692 | 28.83/0.8514 | 29.41/0.8524 | 28.30/0.8354 |
| VideoINR-fixed | 11.31 | 30.73/0.8850 | —/— | 30.21/0.8805 | —/— |
| VideoINR | 11.31 | 30.26/0.8792 | 29.41/0.8669 | 29.92/0.8746 | 29.27/0.8651 |
| MoTIF | 12.55 | 31.04/0.8877 | 30.04/0.8773 | 30.63/0.8839 | 29.82/0.8750 |
| HR-INR | 8.27 | 31.97/0.9298 | 32.13/0.9371 | 31.26/0.9246 | 31.11/0.9216 |

In Table 1, M represents a quantity of parameters, measured in millions; “−/−” represents that a test for a corresponding scenario is not supported; and HR-INR is the video processing method provided in the embodiments of this application.

Results of super-resolution and frame interpolation experiments on the Adobe dataset at different factors are shown in Table 2.

TABLE 2

| | | Super | | | | | |
|---|---|---|---|---|---|---|---|
| Temporal | Spatial | SloMo + | DAIN + | | | | |
| factor | factor | LIIF | LIIF | TMNet | VideoINR | MoTIF | HR-INR |
| 12× | 4× | 25.07/0.7491 | 25.14/0.7497 | 22.38/0.7931 | 27.32/0.7141 | 27.77/0.8230 | 28.87/0.8854 |
| | 6× | 22.91/0.6783 | 22.92/0.6785 | —/— | 24.67/0.7358 | 26.78/0.7908 | 27.14/0.8173 |
| 16× | 4× | 24.42/0.7296 | 24.20/0.7244 | 24.72/0.7526 | 25.81/0.7739 | 25.98/0.7758 | 27.29/0.8556 |
| | 6× | 23.28/0.6883 | 22.80/0.6722 | —/— | 23.86/0.7123 | 25.34/0.7527 | 26.09/0.7954 |
| 6× | 1× | —/— | —/— | —/— | 32.34/0.9545 | 34.77/0.9696 | 38.53/0.9735 |

Results of frame interpolation experiments on the TimeLens++ dataset at different factors are shown in Table 3.

TABLE 3

| | | | 1-skip | | | | | |
|---|---|---|---|---|---|---|---|---|
| | | | Peak signal- | Structural | | | | |
| | | | to-noise ratio | similarity index | | 3-skip | | |
| Method | M | Event | (PSNR) | (SSIM) | LPIPS | PSNR | SSIM | LPIPS |
| FLAVR | — | x | 25.95 | — | 0.086 | 20.90 | — | 0.151 |
| DAIN | 24.0 | x | 25.20 | — | 0.067 | 21.40 | — | 0.113 |
| Super SloMo | 19.8 | x | — | — | — | 22.48 | — | 0.115 |
| QVI | 29.2 | x | — | — | — | 23.20 | — | 0.110 |
| TimeLens | 72.2 | ✓ | 28.36 | — | 0.026 | 27.58 | — | 0.031 |
| TimeLens++ | 53.9 | ✓ | 28.56 | — | 0.022 | 27.63 | — | 0.026 |
| CBMNet | 15.4 | ✓ | 29.32 | 0.815 | — | 28.46 | 0.806 | — |
| CBMNet- | 22.2 | ✓ | 29.43 | 0.816 | — | 28.56 | 0.808 | — |
| Large | | | | | | | | |
| HR-INR | 8.3 | ✓ | 29.66 | 0.828 | 0.011 | 28.59 | 0.814 | 0.021 |

“×” represents that event data is not used. “√” represents that event data is used. “−” represents that a test for a corresponding scenario is not supported.

Results of super-resolution experiments on the CED dataset at different factors are shown in Table 4.

TABLE 4

| | | | | | 2× | |
|---|---|---|---|---|---|---|
| | | | 4× | | | SSIM |
| Method | M | Event | PSNR | SSIM | PSNR | LPIPS |
| DUF | 1.90 | x | 24.43 | 0.8177 | 31.83 | 0.9183 |
| TDAN | 1.97 | x | 27.88 | 0.8231 | 33.74 | 0.9398 |
| SOF | 1.00 | x | 27.00 | 0.8050 | 31.84 | 0.9226 |
| RBPN | 12.18 | x | 29.80 | 0.8975 | 36.66 | 0.9754 |
| BasicVSR++ | 7.30 | x | 14.76 | 0.1641 | — | — |
| VideoINR* | 11.31 | x | 25.53 | 0.7871 | 26.77 | 0.7938 |
| E-VSR | 412.42 | ✓ | 30.15 | 0.9052 | 37.32 | 0.9783 |
| EG-VSR | 2.45 | ✓ | 31.12 | 0.9211 | 38.69 | 0.9771 |
| HR-INR | 8.27 | ✓ | 32.15 | 0.9658 | 42.01 | 0.9905 |

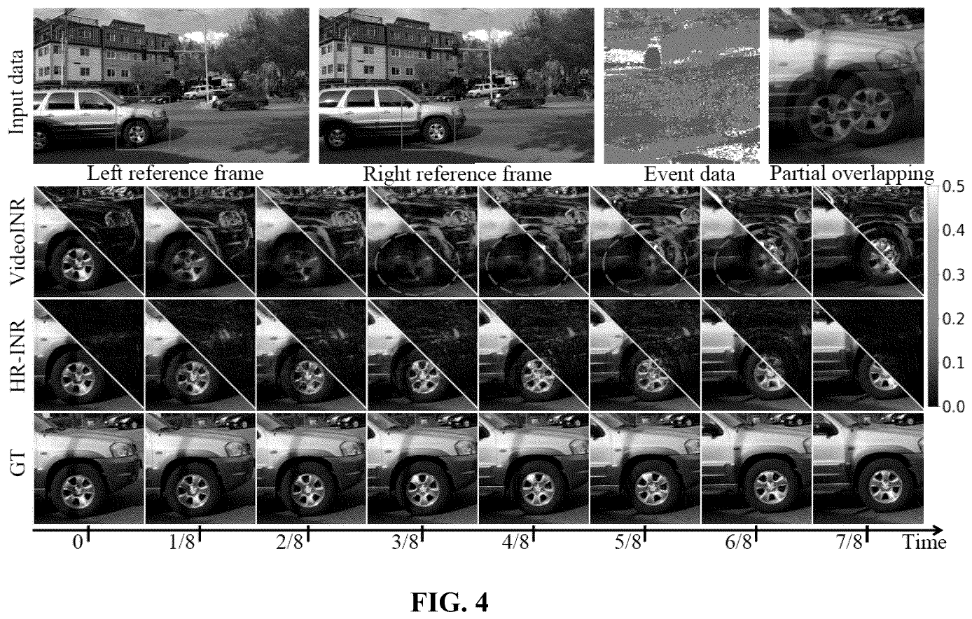

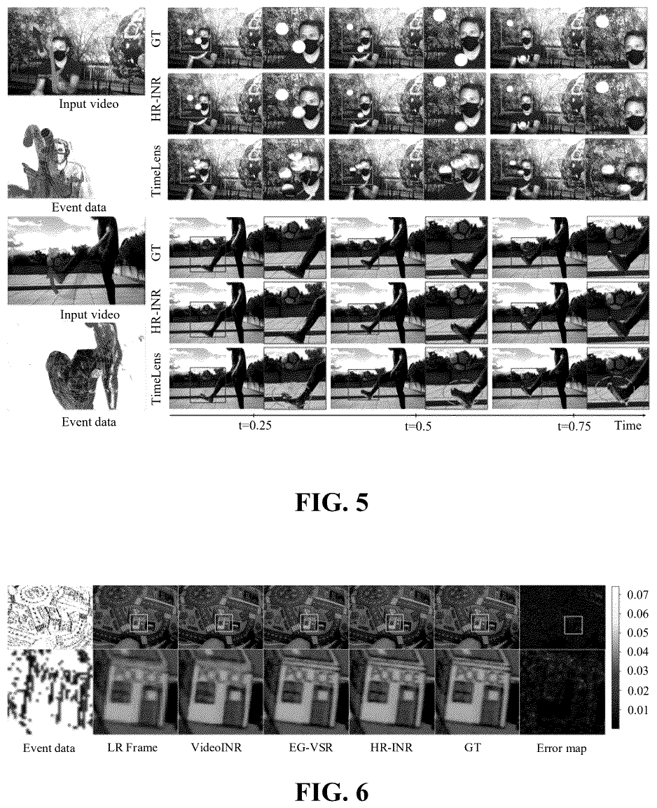

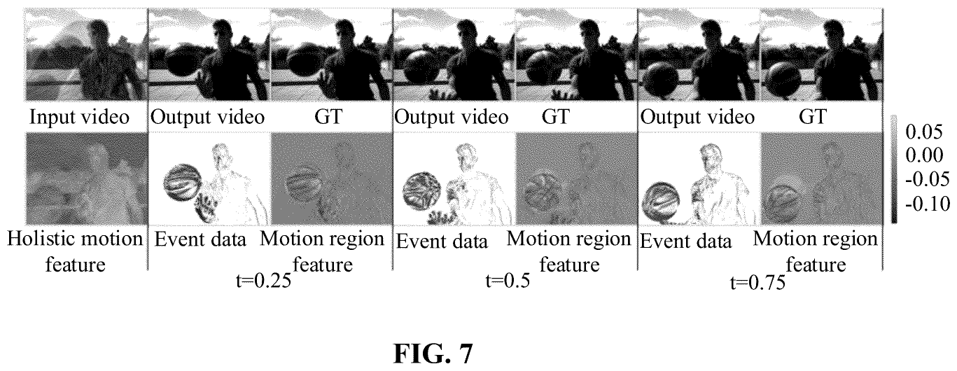

FIG. 4 to FIG. 7 show experimental visualization results corresponding to different datasets. FIG. 4 shows experimental visualization results on the Adobe dataset. FIG. 5 shows experimental visualization results on the TimeLens++ dataset. FIG. 6 shows experimental visualization results on the CED dataset. FIG. 7 shows experimental visualization results on the TimeLens++ dataset.

It can be learned from the experiment results shown in Table 1 to Table 4 and FIG. 5 to FIG. 7 that the method provided in this application captures dynamics of a rotating tire more effectively than VideoINR, demonstrating the HR-INR framework's advantages in handling fast motion and restoring details.

It can be learned from the foregoing verification experiments and experiment results that the method provided in the embodiments of this application achieves significant progress and effects in technical, economic, and social aspects, which are specifically as follows:

The method provided in the embodiments of this application significantly improves a resolution and frame rate of a video while addressing a challenge of capturing fast and nonlinear motion. In comparison with the prior art, the method provided in the embodiments of this application can decode a video at an arbitrary resolution while maintaining a high temporal resolution and low latency. In addition, it can be learned from the results of the verification experiments that the method provided in the embodiments of this application outperforms a traditional INR-based method on all four datasets, especially when handling fast motion and complex scenes. A PSNR is improved by 3 dB to 5 dB, and an SSIM is improved by 0.05 to 0.1, proving a video processing capability and generalization performance of the method provided in the embodiments of this application.

In the economic aspect, by improving efficiency and quality of a video processing technology, the method provided in the embodiments of this application can bring significant economic benefits to a plurality of fields such as video content providers, safety monitoring systems, and autonomous vehicles. For example, in the field of safety monitoring, the method provided in the embodiments of this application can deliver a clearer video image without incurring additional hardware costs, to improve event detection accuracy and efficiency and reduce economic losses caused by poor monitoring quality.

In the social aspect, the method provided in the embodiments of this application is of great significance for promoting development of VR and augmented reality (AR) technologies while improving video quality. High-quality video input is a key to improving realism of VR/AR experience. The method provided in the embodiments of this application can provide a user with more immersive and realistic virtual experience, to promote progress in social application to a plurality of fields such as education, entertainment, and medical treatment.

In a test on an Adobe240 dataset, the method provided in the embodiments of this application achieves significant improvements in comparison with the prior art when performing 4× spatial upsampling and 8× video frame interpolation (as demonstrated by data shown in Table 1 to Table 4). The method provided in the embodiments of this application is significantly superior to a traditional video super-resolution and frame rate improvement technology. In addition, in an application test on an actual monitoring video dataset, the method provided in the embodiments of this application can restore clearly identifiable face and license plate information under conditions of extremely low illumination and high-speed motion, confirming its effectiveness and reliability in practical application.

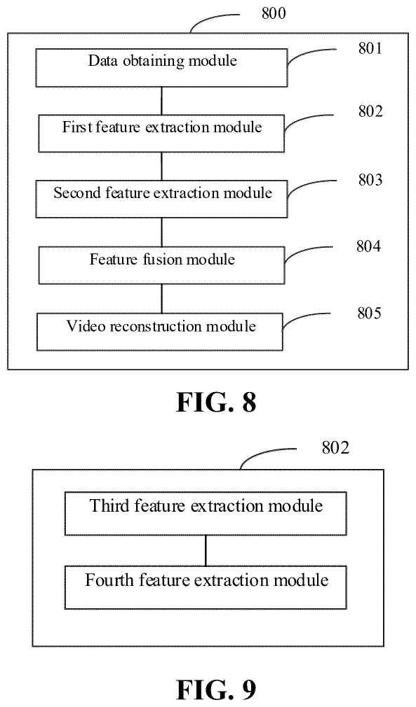

The embodiments of this application further provide a video processing apparatus. As shown in FIG. 8, the video processing apparatus 800 includes a data obtaining module 801, a first feature extraction module 802, a second feature extraction module 803, a feature fusion module 804, and a video reconstruction module 805.

The data obtaining module 801 is configured to obtain a to-be-processed video acquired by an event camera and event data corresponding to the to-be-processed video.

The first feature extraction module 802 is configured to perform event feature extraction on the event data to obtain a motion region feature corresponding to the to-be-processed video.

The second feature extraction module 803 is configured to perform frame feature extraction on the to-be-processed video and the event data to obtain a holistic motion feature corresponding to the to-be-processed video. The holistic motion feature is used to represent a dependency with respect to time and space of the to-be-processed video.

The feature fusion module 804 is configured to fuse the motion region feature and the holistic motion feature to obtain a fused feature.

The video reconstruction module 805 is configured to perform video reconstruction based on the fused feature to obtain a target video.

In an example, as shown in FIG. 9, the first feature extraction module includes a third feature extraction module and a fourth feature extraction module. The third feature extraction module is configured to perform event feature extraction on the event data to obtain motion feature information corresponding to the to-be-processed video. The fourth feature extraction module is configured to perform regional event feature extraction on the motion feature information to obtain the motion region feature corresponding to the to-be-processed video.

In an example, the third feature extraction module is specifically configured to perform multi-level temporal pyramid representation on the event data by using a time granularity corresponding to each pyramid level in a temporal pyramid model to obtain the motion feature information corresponding to the to-be-processed video.

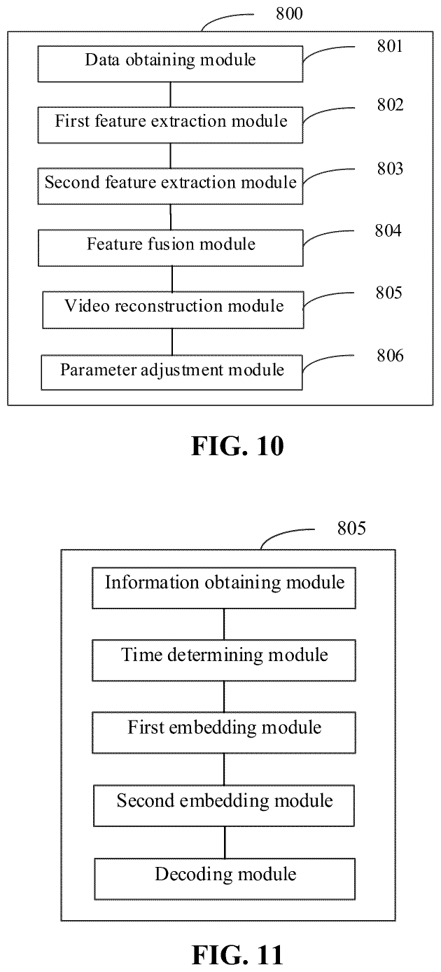

In an example, as shown in FIG. 10, the video processing apparatus further includes a parameter adjustment module 806 configured to obtain dynamic characteristic data in the to-be-processed video; and adjust a level parameter corresponding to each pyramid level in the temporal pyramid model based on the dynamic characteristic data. The dynamic characteristic data is used to represent motion data of a moving object in the to-be-processed video.

In an example, the third feature extraction module is specifically configured to obtain dynamic characteristic data of at least one moving object in the to-be-processed video; determine a time window corresponding to the dynamic characteristic data of the at least one moving object based on a relationship between the dynamic characteristic data and the time window; and encode the event data by using the time window corresponding to the dynamic characteristic data of the at least one moving object to obtain the motion feature information corresponding to the to-be-processed video. The dynamic characteristic data is used to represent motion data of the at least one moving object in the to-be-processed video.

In an example, the fourth feature extraction module is specifically configured to extract local dynamic change information and edge information in the motion feature information through a convolutional layer of a neural network and a multi-head self-attention mechanism to obtain the motion region feature corresponding to the to-be-processed video.

In an example, as shown in FIG. 11, the video reconstruction module includes an information obtaining module, a time determining module, a first embedding module, a second embedding module, and a decoding module. The information obtaining module is configured to obtain a target frame rate and a target resolution corresponding to the target video. The time determining module is configured to determine a display time corresponding to each frame of image in the target video based on the target frame rate. The first embedding module is configured to perform temporal embedding on the fused feature to obtain a first fused feature corresponding to the display time. The second embedding module is configured to perform spatial embedding on the first fused feature to obtain a second fused feature corresponding to the target resolution. The decoding module is configured to decode the second fused feature to obtain the target video with the target frame rate and the target resolution.

In an example, the decoding module is specifically configured to segment the to-be-processed video to obtain a plurality of regional videos; determine the second fused feature corresponding to each of the regional videos based on an association relationship between the regional videos and the second fused feature; decode the second fused feature corresponding to each of the regional videos through a corresponding decoding strategy based on an association relationship between the decoding strategy and the second fused feature to obtain a target regional video corresponding to each of the regional videos; and combine the target regional videos corresponding to the plurality of regional videos to obtain the target video.

The video processing apparatus provided in the embodiments of this application can implement each process implemented in the foregoing method embodiments. To avoid repetition, details are not described herein again.

The present disclosure further provides another embodiment of the video processing apparatus. In this embodiment, the video processing apparatus includes a processor. The processor is configured to execute the following program modules stored in a memory: the data obtaining module 801, first feature extraction module 802, second feature extraction module 803, feature fusion module 804, video reconstruction module 805, third feature extraction module, fourth feature extraction module, parameter adjustment module 806, information obtaining module, time determining module, first embedding module, second embedding module, decoding module, feature extraction module, data representation unit, regional event feature extractor, holistic event feature extractor, and decoding unit.

Those skilled in the art should clearly understand that, for convenient and concise description, only the division of the above-mentioned functional units/modules is used as an example for illustration. In practical application, the above-mentioned functions may be realized by different functional units/modules as required, that is, the internal structure of the apparatus is divided into different functional units or modules to complete all or part of the above-described functions. The functional units/modules in the embodiments may be integrated into one processing unit, or each of the units may exist alone physically, or two or more units are integrated into one unit. The above integrated unit may be implemented either in a form of hardware or in a form of a software functional unit. In addition, specific names of the functional units/modules are only for the convenience of distinguishing each other, and are not intended to limit the protection scope of the present disclosure. For specific working processes of the units/modules in the above system, reference may be made to the corresponding processes in the above method embodiment, and details are not described herein again.

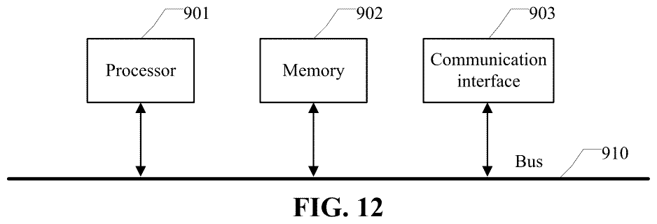

FIG. 12 is a schematic structural diagram of hardware of an electronic device according to an embodiment of this application.

Specifically, the electronic device may include a processor 901 and a memory 902 storing computer program instructions.

Specifically, the processor 901 may include a central processing unit (CPU) or an Application Specific Integrated Circuit (ASIC), or may be configured as one or more integrated circuits for implementing the embodiments of this application.

The memory 902 may include a mass memory for data or instructions. By way of example but not limitation, the memory 902 may include a hard disk drive (HDD), a floppy disk drive, a flash memory, an optical disk, a magnetic disk, a magnetic tape, or a universal serial bus (USB) drive, or a combination of two or more of these. If appropriate, the memory 902 may include a removable or non-removable (or fixed) medium. If appropriate, the memory 902 may be inside or outside of the electronic device. In a specific embodiment, the memory 902 is a nonvolatile solid-state memory.

The memory 1102 may include a read-only memory (ROM), a random access memory (RAM), a disk storage media device, an optical storage media device, a flash memory device, or an electrical, optical, or another physical/tangible memory storage device. Thus, typically, the memory includes one or more tangible (non-transitory) computer-readable storage media (for example, a memory device) encoded with software that includes computer-executable instructions. When the software is executed (for example, by one or more processors), the operations described with reference to the method according to an aspect of the present disclosure may be performed.

The processor 901 reads and executes computer program instructions stored in the memory 902, to implement the video processing method according to any of the embodiments.

In an example, the electronic device may further include a communication interface 903 and a bus 910. As shown in FIG. 9, the processor 901, the memory 902, and the communication interface 903 are connected through the bus 910 to complete mutual communication.

The communication interface 903 is mainly configured to implement the communication between the modules, devices, units, and/or equipment in the embodiments of this application.

The bus 910 includes hardware, software, or both, to couple the components of the electronic device to each other. By way of example but not limitation, the bus may include an accelerated graphics port (AGP) or another graphics bus, an extended industry standard architecture (EISA) bus, a front-side bus (FSB), a hypertransport (HT) interconnect, an industry standard architecture (ISA) bus, an InfiniBand interconnect, a low pin count (LPC) bus, a memory bus, a microchannel architecture (MCA) bus, a peripheral component interconnect (PCI) bus, a PCI-Express (PCI-X) bus, a Serial Advanced Technology Attachment (SATA) bus, a Video Electronics Standards Association local bus (VLB), or another suitable bus or a combination of two or more of these. If appropriate, the bus 910 may include one or more buses. Although specific buses are described and illustrated in the embodiments of this application, any suitable bus or interconnect may be used in this application.

In addition, an embodiment of this application may provide a non-transitory computer-readable storage medium to implement the video processing method in the foregoing embodiments. The non-transitory computer-readable storage medium stores computer program instructions. When the computer program instructions are executed by a processor, the video processing method in any of the foregoing embodiments is implemented.

In addition, an embodiment of this application may provide a computer program product to implement the video processing method in the foregoing embodiments. The computer program product includes a non-transitory computer-readable storage medium containing computer-readable program code. When the computer-readable program code in the computer program product is executed by a processor of an electronic device, the electronic device performs the video processing method according to the above embodiments.

It is to be clear that this application is not limited to the particular configuration and processing described above and illustrated in the accompanying drawings. A detailed description of the known method is omitted herein for the sake of brevity. In the above embodiments, several specific steps are described and illustrated as examples. However, the method of this application is not limited to the specific steps described and illustrated, and a person skilled in the art may make various changes, modifications and additions, or change the step sequence based on the spirit of this application.

The functional blocks shown in the structural block diagrams described above may be implemented as hardware, software, firmware, or a combination thereof. When implemented in hardware, the functional block may be, for example, an electronic circuit, an ASIC, appropriate firmware, a plug-in, a function card, or the like. When implemented in software, the elements of this application are programs or code segments that are used to perform the required task. The program or code segment may be stored in a machine-readable medium or transmitted on a transmission medium or communication link via a data signal carried in a carrier wave. A “machine-readable medium” may include any medium capable of storing or transmitting information. Examples of the machine-readable medium include an electronic circuit, a semiconductor memory device, a ROM, a flash memory, an erasable ROM (EROM), a floppy disk, a CD-ROM, an optical disk, a hard disk, a fiber optic medium, a radio frequency (RF) link, and the like. The code segment may be downloaded via computer networks such as the Internet or Intranets.

It is also noted that the exemplary embodiments mentioned in this application describe some methods or systems based on a series of steps or devices. However, this application is not limited to the above step sequence, that is, the steps may be performed in the sequence in the embodiments or in a sequence different from the sequence in the embodiments, or several steps may be performed simultaneously.

Various aspects of the present disclosure are described with reference to flowcharts and/or block diagrams of the video processing methods, devices, computer-readable storage media and computer program products according to embodiments of the present disclosure. It should be understood that each block of the flowcharts and/or block diagrams, and combinations of blocks in the flowcharts and/or block diagrams, can be implemented by the computer program instructions. The compute program instructions can be provided to a processor of a general-purpose computer, a dedicated computer, or other programmable data processing device, to produce a machine that makes the instruction when executed by the processor of the computer or other programmable data processing devices to implement the functions/actions specified in one or more blocks in the flowcharts and/or block diagrams. Such a processor may be, but is not limited to, a general purpose processor, an application specific processor, or a field programmable logic circuit. It should also be noted that each block in the flowcharts and/or block diagrams and combinations of the blocks in the flowcharts and/or block diagrams may be implemented by dedicated hardware for executing specified functions or operations, or may be implemented by a combination of dedicated hardware and computer instructions.

The foregoing descriptions are merely specific implementations of this application. A person skilled in the art can clearly understand that, for convenience and brevity of description, reference may be made to corresponding processes in the foregoing method embodiments for specific working processes of the foregoing systems, apparatuses, and units. Details are not described herein again. It should be understood that the protection scope of this application is not limited herein. Any equivalent modification or replacement readily figured out by a person skilled in the art within the technical scope disclosed in the present invention shall fall within the protection scope of the present invention.

1. A video processing method, comprising:
obtaining a to-be-processed video acquired by an event camera and event data corresponding to the to-be-processed video;
performing event feature extraction on the event data to obtain a motion region feature corresponding to the to-be-processed video;
performing frame feature extraction on the to-be-processed video and the event data to obtain a holistic motion feature corresponding to the to-be-processed video, wherein the holistic motion feature is used to represent a dependency with respect to time and space of the to-be-processed video;
fusing the motion region feature and the holistic motion feature to obtain a fused feature; and
performing video reconstruction based on the fused feature to obtain a target video.

2. The method according to claim 1, wherein the performing event feature extraction on the event data to obtain a motion region feature corresponding to the to-be-processed video comprises:
performing event feature extraction on the event data to obtain motion feature information corresponding to the to-be-processed video; and
performing regional event feature extraction on the motion feature information to obtain the motion region feature corresponding to the to-be-processed video.

3. The method according to claim 2, wherein the performing event feature extraction on the event data to obtain motion feature information corresponding to the to-be-processed video comprises:
performing multi-level temporal pyramid representation on the event data by using a time granularity corresponding to each pyramid level in a temporal pyramid model to obtain the motion feature information corresponding to the to-be-processed video.

4. The method according to claim 3, before the performing multi-level temporal pyramid representation on the event data by using a time granularity corresponding to each pyramid level in a temporal pyramid model to obtain the motion feature information corresponding to the to-be-processed video, further comprising:
obtaining dynamic characteristic data in the to-be-processed video, wherein the dynamic characteristic data is used to represent motion data of a moving object in the to-be-processed video; and
adjusting a level parameter corresponding to each pyramid level in the temporal pyramid model based on the dynamic characteristic data.

5. The method according to claim 2, wherein the performing event feature extraction on the event data to obtain motion feature information corresponding to the to-be-processed video comprises:
obtaining dynamic characteristic data of at least one moving object in the to-be-processed video, wherein the dynamic characteristic data is used to represent motion data of the at least one moving object in the to-be-processed video;
determining a time window corresponding to the dynamic characteristic data of the at least one moving object based on a relationship between the dynamic characteristic data and the time window; and
encoding the event data by using the time window corresponding to the dynamic characteristic data of the at least one moving object to obtain the motion feature information corresponding to the to-be-processed video.

6. The method according to claim 2, wherein the performing regional event feature extraction on the motion feature information to obtain the motion region feature corresponding to the to-be-processed video comprises:
extracting local dynamic change information and edge information in the motion feature information through a convolutional layer of a neural network and a multi-head self-attention mechanism to obtain the motion region feature corresponding to the to-be-processed video.

7. The method according to claim 1, wherein the performing video reconstruction based on the fused feature to obtain a target video comprises:
obtaining a target frame rate and a target resolution corresponding to the target video;
determining a display time corresponding to each frame of image in the target video based on the target frame rate;
performing temporal embedding on the fused feature to obtain a first fused feature corresponding to the display time;
performing spatial embedding on the first fused feature to obtain a second fused feature corresponding to the target resolution; and
decoding the second fused feature to obtain the target video with the target frame rate and the target resolution.

8. The method according to claim 7, wherein the decoding the second fused feature to obtain the target video with the target frame rate and the target resolution comprises:
segmenting the to-be-processed video to obtain a plurality of regional videos;
determining the second fused feature corresponding to each of the regional videos based on an association relationship between the regional videos and the second fused feature;
decoding the second fused feature corresponding to each of the regional videos through a corresponding decoding strategy based on an association relationship between the decoding strategy and the second fused feature to obtain a target regional video corresponding to each of the regional videos; and
combining the target regional videos corresponding to the plurality of regional videos to obtain the target video.

9. A video processing apparatus, comprising:
a data obtaining module configured to obtain a to-be-processed video acquired by an event camera and event data corresponding to the to-be-processed video;
a first feature extraction module configured to perform event feature extraction on the event data to obtain a motion region feature corresponding to the to-be-processed video;
a second feature extraction module configured to perform frame feature extraction on the to-be-processed video and the event data to obtain a holistic motion feature corresponding to the to-be-processed video, wherein the holistic motion feature is used to represent a dependency with respect to time and space of the to-be-processed video;
a feature fusion module configured to fuse the motion region feature and the holistic motion feature to obtain a fused feature; and
a video reconstruction module configured to perform video reconstruction based on the fused feature to obtain a target video.

10. An electronic device, comprising: a processor and a memory that stores a computer program instruction; wherein
the processor, when executing the computer program instruction, implements the video processing method according to claim 1.

11. A non-transitory computer-readable storage medium, wherein the non-transitory computer-readable storage medium stores a computer program instruction, and the computer program instruction, when executed by a processor, implements the video processing method according to claim 1.

12. A non-transitory computer-readable storage medium, wherein the non-transitory computer-readable storage medium stores a computer program instruction, and the computer program instruction, when executed by a processor, implements the video processing method according to claim 2.

13. A computer program product, comprising: a non-transitory computer-readable storage medium that contains computer-readable program code, wherein the computer-readable program code in the computer program product, when executed by a processor of an electronic device, causes the electronic device to perform the video processing method according to claim 1.

14. A computer program product, comprising: a non-transitory computer-readable storage medium that contains computer-readable program code, wherein the computer-readable program code in the computer program product, when executed by a processor of an electronic device, causes the electronic device to perform the video processing method according to claim 2.

15. A computer program product, comprising: a non-transitory computer-readable storage medium that contains computer-readable program code, wherein the computer-readable program code in the computer program product, when executed by a processor of an electronic device, causes the electronic device to perform the video processing method according to claim 3.

16. A computer program product, comprising: a non-transitory computer-readable storage medium that contains computer-readable program code, wherein the computer-readable program code in the computer program product, when executed by a processor of an electronic device, causes the electronic device to perform the video processing method according to claim 4.

17. A computer program product, comprising: a non-transitory computer-readable storage medium that contains computer-readable program code, wherein the computer-readable program code in the computer program product, when executed by a processor of an electronic device, causes the electronic device to perform the video processing method according to claim 5.

18. A computer program product, comprising: a non-transitory computer-readable storage medium that contains computer-readable program code, wherein the computer-readable program code in the computer program product, when executed by a processor of an electronic device, causes the electronic device to perform the video processing method according to claim 6.

19. A computer program product, comprising: a non-transitory computer-readable storage medium that contains computer-readable program code, wherein the computer-readable program code in the computer program product, when executed by a processor of an electronic device, causes the electronic device to perform the video processing method according to claim 7.

20. A computer program product, comprising: a non-transitory computer-readable storage medium that contains computer-readable program code, wherein the computer-readable program code in the computer program product, when executed by a processor of an electronic device, causes the electronic device to perform the video processing method according to claim 8.
